(19) United States
(12) Patent Application Publication
(10) Pub. No.: US 2005/0130502 A1
(43) Pub. Date: Jun. 16, 2005

(54) Coupling for the mechanical and electrical connection of lighting devices

(76) Inventor: Gianbattista Scalfi, Bovezzo (IT)

Correspondence Address: MCGLEW & TUTTLE, PC, P.O. BOX 9227, SCARBOROUGH STATION, SCARBOROUGH, NY, 10510-9227, US

(21) Appl. No.: 10/510,847

(22) PCT Filed: Apr. 8, 2003
(86) PCT No.: PCT/IT03/00217

(30) Foreign Application Priority Data
Oct. 23, 2003 (IT) BS2002U000043

(51) Int. Cl. H01R 25/00

(52) U.S. Cl. 439/638

(57) ABSTRACT

The invention relates to a coupling member for the mechanical and electrical connection of lighting device in line and/or angled for the formation of lighting system. The coupling includes a junction body (11) having more sides and on each side mechanical connecting means (18) and an electrical end connector (16), which link up with complementary elements, both mechanical (23) and electrical (21), at the edges of each lighting device (19) to be connected. The junction body bears four sides and the electrical connector along the sides are precableable.

### FIELD OF THE INVENTION

The present invention relates to lighting devices and refers in particular to an connection element for adjoining lighting devices designed for the composition of hanging lighting systems.

### PRIOR ART

Lighting systems are usually produced connecting more lighting devices in line and/or angled following the requested course. The connection must be both physical, mechanical, and electrical for the continuity of the lighting bodies. Usually, for such a connection are used straight elements, at angle, T-shaped, etc. Therefore, many connection elements different according to the request, will have be constructed, with relative increase of cost of fulfillment and management of the same elements and more labour and discomfort in carrying out the required connections.

### OBJECT AND SUMMARY OF THE INVENTION

One of the objects of the present invention is to provide a connecting element able to eliminate the disadvantages of the well-known technique and to allow, with the same element, a mechanical and electrical link of two, three or four devices, selectively.

Another object of the invention is to provide a modular connection element having four mechanical and electrical connection systems on the same number of sides, employeable according to the needs and disguiseable when not in use.

A further object of the invention is to provide a connecting element able to simplify the connection of lighting devices, whether in line, or angled, without having to dispose of special tools, only using a screwdriver for mechanical fixing.

The above-mentioned objects and the implicit advantages that follow, are achieved, in accordance with the invention by a coupling member for connecting more lighting devices in line and/or angled to construct lighting systems, which incorporates a substantial square body and, on each side of said body, connecting mechanical means and an electrical end connector, said mechanical means and electrical connector connecting with complementary means provided at the ends of each lighting device: to connect.

The coupling member may also have a body fillet shaped, designed to interpose between two lighting devices dispose in line and with the passage of mechanical means and the electrical connector to link the same devices.

### BRIEF DESCRIPTION OF THE INVENTION

Further details of the invention will result however evident by the following description made with reference to the enclosed drawings, indicative and not restrictive, in which:

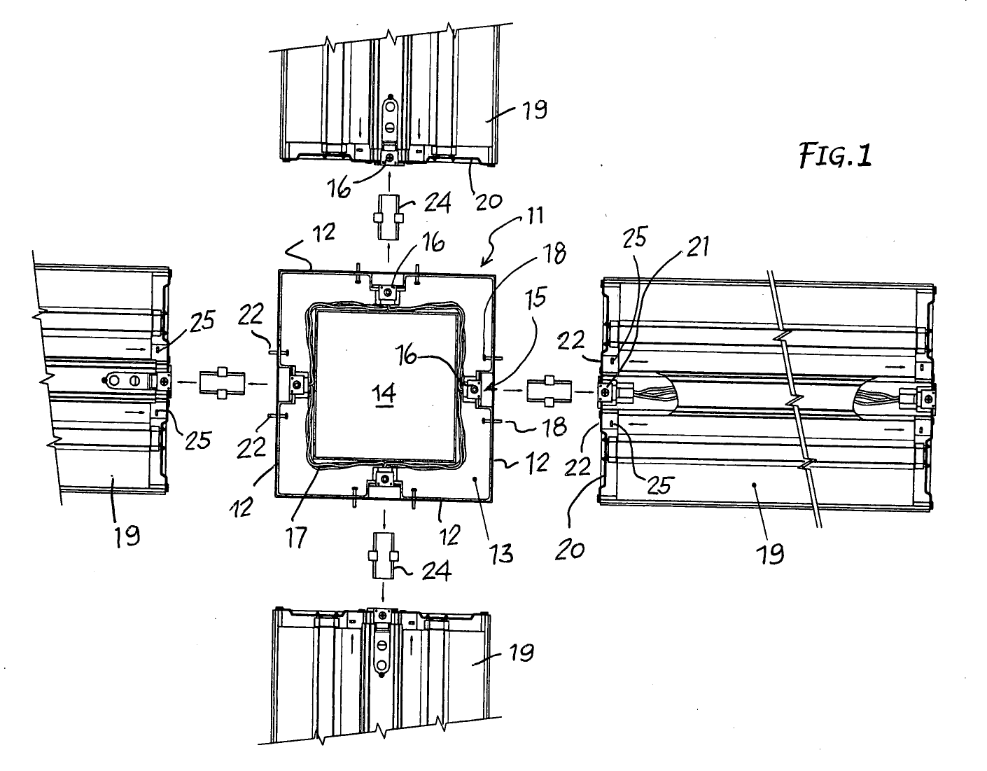

FIG. 1 shows a plan view of the connecting coupling and around it, lighting devices that can be connected, both mechanically and electrically;

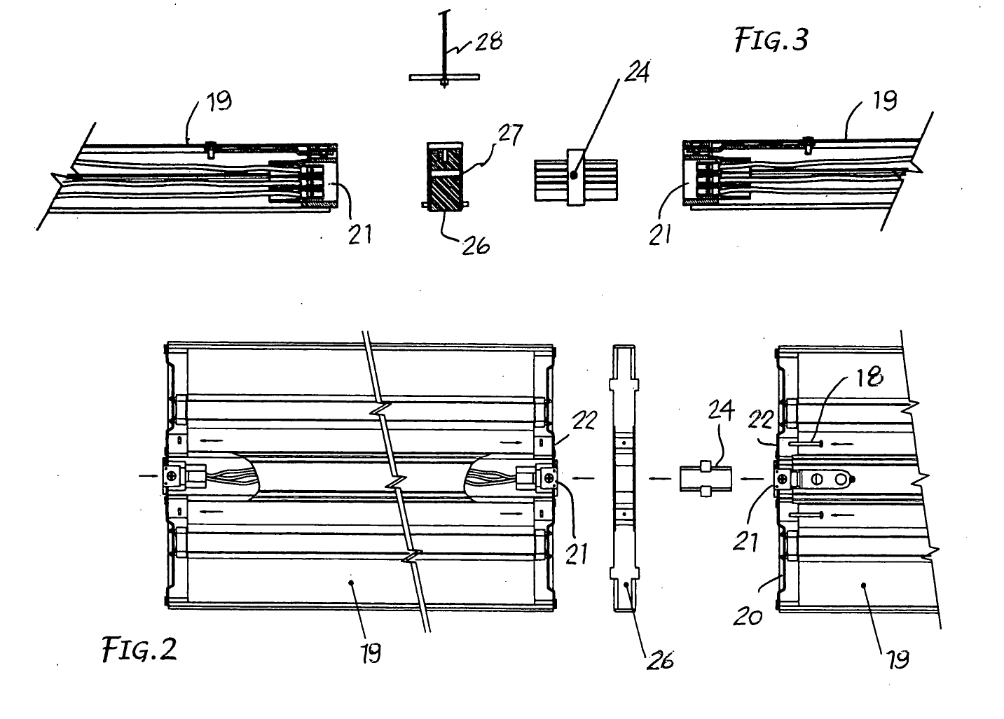

FIG. 2 shows, also in plan view, a variation of the coupling designed for a mechanical and electrical connection for only two devices in line;

FIG. 3 shows a side view in section, magnified, of the coupling member in FIG. 2;

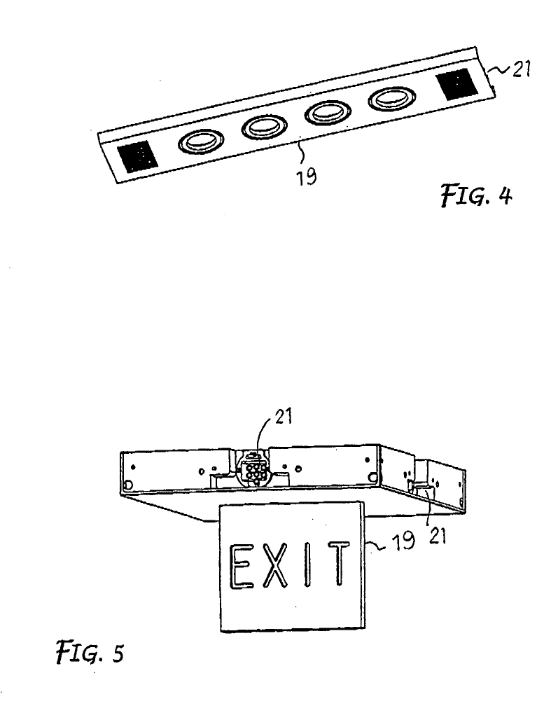

FIG. 4 is an example of lighting device from below; end FIG. 5 is another type of device to be connected.

### DETAILED DESCRIPTION OF THE INVENTION

The connecting coupling as shown in FIG. 1, incorporates a connecting body 11 having four square sides 12 which project from a base 13, in which an opening 14 is provided centraly, even if not necessarily.

Along each side 12 of said body a recess 15 is provided in which an electrical end connector 16, exposed and accessible sideways, is arranged and restrained. The electrical connectors 16 on the sides 12 of the body 11 are originally precabled, that is connected among each other through electrical cables 17, according to the need.

On each side 12 of the body 11, on opposite side of the recess 15 that houses the electrical end connectors 6 at least two holes are obtained in order to allow the passage of the same numner of the fixing screws 18.

Each lighting device 19 to be connected with others by the above-mentioned connecting coupling, is provided in each end with a terminal breast band 20 bearing a electrical connector 21 similar to the one placed on the body 11 of the coupling and at least two holes 22 located on both opposite sides of said electrical connector 21.

As shown, the electrical connector 21 on the lighting device 19 is placed in front and lined with the electrical connector 16 on one of facing sides 12 of the body 11; in the same way the holes 22 in the terminal breast band 20 coincide with the holes on the same side 12 of the body 11.

Therefore, the junction body 11 can be used to connect, in the same way, two, three or four lighting devices 19 in line, angled, T-shaped or cross-shaped according to the need, that is in accordance with the course of the lighting system to produce.

For the electrical connection the facing end connector 16, 21 must be coupled through an intermediate electrical connector 24, that is complementary. Then the mechanical fixing is made by the screws 18, that are to be lodged in the coincident holes 22 of the adjacent sides of the body 11 and of the lighting device 19 and that are to be screwed in the corresponding nuts 25, which in the represented example are situated inside the terminal breast band of the lighting device.

In the variation in FIGS. 2 and 3, the coupling body is shown in the shape of a fillet 26 that interposes between two lighting devices in line 19 each one provided, likewise what has been mentioned above, with a terminal breast band 20 bearing an electrical end connector 21 and at least two holes 22. With this arrangement, the fillet has some holes 27 for the screws 18 that fix the devices among each other and at least a recess in which the intermediate electrical connector 24 passes. A suspension cable 28 can also be fixed to the fillet.

1. A coupling member for a mechanical and electrical connection of lighting devices in fine and/or angled for alighting devices formation, characterized in that it includes a junction body having more sides and, on each body side, mechanical junction means and an electrical end connector, said mechanical means and electrical connector linking together with complementary elements, respectively mechanical and electrical, located at the ends of each lighting device.

2. Coupling member according to claim 1, wherein said junction body has four square sides, one electrical end connector placed and fixed along each side and at least two holes on the opposite side of the electrical connector, on each side of said body.

3. Coupling member according to claim 1, wherein the electrical end connectors on the junction body are electrically preconnected.

4. Coupling member according to claim 1, for which each lighting device presents a terminal breast band bearing an electrical end connector and at least two holes on lateral sides of said electrical connector, wherein the electrical connector on one side of the junction body is lined up with the electrical connector on the terminal breast band of the lighting device, and said lined up connectors are linked together through an intermediate electrical connector, whereas the holes on one side of the body and the holes of the terminal breast band of said device coincide and lodge screws for mechanical fixing between coupling body and the electrical device.

5. A lighting system including more lighting devices placed in line and/or angled, characterized by the fact that such devices are mechanically and electrically connectable through a coupling member having four square sides, an electrical end connector placed and fixed along each side and at least two holes on the opposite sides of said electrical connector on each side of the body, the electrical end connectors on the connecting body being electrically pre-linked, each lighting device bearing a terminal breast band and an electrical end connector and at least two holes on each opposite sides of said electrical connector, the electrical connector on one (inked side being fined up with the electrical connector on the terminal breast band of the lighting device, whereas said lined up connectors are linked through an intermediate electrical connector, the holes of one side of said coupling member and the holes in the terminal breast band of said lighting device coincide and receive screws for the mechanical fixing the electrical device.

6. Coupling member according to claim 2, wherein the electrical end connectors on the junction body are electrically preconnected.

7. Coupling member according to claim 2, for which each lighting device presents a terminal breast band bearing an electrical end connector and at least two holes on lateral sides of said electrical connector, wherein the electrical connector on one side of the junction body is lined up with the electrical connector on the terminal breast band of the lighting device, and said lined up connectors are linked together through an intermediate electrical connector, whereas the holes on one side of the body and the holes of the terminal breast band of said device coincide and lodge screws for mechanical fixing between coupling body and the electrical device.

8. Coupling member according to claim 3, for which each lighting device presents a terminal breast band bearing an electrical end connector and at least two holes on lateral sides of said electrical connector, wherein the electrical connector on one side of the junction body is lined up with the electrical connector on the terminal breast band of the lighting device, and said lined up connectors are linked together through an intermediate electrical connector, whereas the holes on one side of the body and the holes of the terminal breast band of said device coincide and lodge screws for mechanical fixing between coupling body and the electrical device.
